(19) United States
(12) Patent Application Publication
(10) Pub. No.: US 2026/0269983 A1
(43) Pub. Date: Sep. 10, 2026

(54) TRANSPORT BLOCK SIZE (TBS) INFORMATION COMMUNICATION FOR TRANSPORT BLOCK (TB) RE-TRANSMISSION

(71) Applicant: QUALCOMM Incorporated, San Diego, CA (US)

(72) Inventors: Konstantin KUPERSHLAK, Ramat Gan (IL); Ran BERLINER, Kfar Aviv (IL); Shay LANDIS, Hod Hasharon (IL); Amit BAR-OR TILLINGER, Tel-Aviv (IL); Eitan YERUSHALMI, Tel Aviv (IL); Girish KHANDELWAL, San Diego, CA (US)

(21) Appl. No.: 19/075,463

(22) Filed: Mar. 10, 2025

(51) Int. Cl. H04L 1/08; H04L 1/00

(52) U.S. Cl. CPC H04L 1/08; H04L 1/0003

(57) ABSTRACT

Certain aspects of the present disclosure provide techniques for transport block (TB) re-transmission. A method generally includes receiving a first downlink control message that schedules a re-transmission of a first TB, the first downlink control message comprising: a first special modulation and coding scheme (MCS) index that indicates a first modulation order for the re-transmission of the first TB; and information about a first TB size (TBS) for the re-transmission of the first TB; and based on the first downlink control message, performing one or more actions, wherein the one or more actions comprise: detecting the re-transmission of the first TB and decoding the first TB based on the first special MCS index and the information about the first TBS; or sending the re-transmission of the first TB according to the first special MCS index and the information about the first TBS.

### FIELD OF THE DISCLOSURE

Aspects of the present disclosure relate to wireless communications, and more particularly, to techniques for transport block (TB) re-transmission.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes receiving a first downlink control message that schedules a re-transmission of a first transport block (TB), the first downlink control message comprising: a first modulation and coding scheme (MCS) index that indicates a first modulation order for the re-transmission of the first TB; and first TB size (TBS) information for the re-transmission of the first TB; and performing one or more actions based on the first downlink control message, wherein the one or more actions comprise: detecting the re-transmission of the first TB and decoding the first TB based on the first MCS index and the first TBS information; or sending the re-transmission of the first TB according to the first MCS index and the first TBS information.

Certain aspects provide a method for wireless communications by a network entity. The method includes sending a first downlink control message that schedules a re-transmission of a first TB, the first downlink control message comprising: a first MCS index that indicates a first modulation order for the re-transmission of the first TB; and first TBS information for the re-transmission of the first TB; and performing one or more actions based on the first downlink control message, wherein the one or more actions comprise: sending the re-transmission of the first TB according to the first MCS index and the first TBS information; or detecting the re-transmission of the first TB and decoding the first TB based on the first MCS index and the first TBS information.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 is a diagram depicting an example of an uplink transmission coding chain.

FIG. 6 depicts an example modulation and coding scheme (MCS) table, which includes regular and reserved MCS.

FIG. 7 depicts a process flow for communications in a network between a network entity and a UE for the re-transmission of a TB via a downlink communications channel.

FIG. 8 depicts another process flow for communications in a network between a network entity and a UE for the re-transmission of a TB via an uplink communications channel.

FIG. 9 depicts another process flow for communications in a network between a network entity and a UE for the re-transmission of a TB via a downlink communications channel.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for communicating transport block size (TBS) information for a scheduled re-transmission of a transport block (TB). The re-transmission of the TB may be a re-transmission that is scheduled to use a reserved modulation and coding scheme (MCS) (e.g., for modulation and encoding), or more specifically, an MCS indicating that the TBS for the re-transmission of the TB may be based on another downlink control message used to schedule an initial transmission of the TB. Additional details related to reserved MCS and TBS are provided below.

Certain wireless communications systems (e.g., an Evolved Universal Terrestrial Radio Access (E-UTRA) system, 5G New Radio (NR) system, and/or any future wireless communication system) may include one or more network entities (e.g., such as one or more base stations (BSs)) that support communication for a user equipment (UE) or multiple UEs. A UE may communicate with a network entity via downlink communications and uplink communications. “Downlink” (or “DL”) may refer to a communication link from the network entity to the UE, and “uplink” (or “UL”) may refer to a communication link from the UE to the network entity.

Information communicated between a network entity and a UE (e.g., either via downlink or uplink communication) may be represented as a sequence of binary bits (e.g., the smallest unit of information on a machine), also referred to herein as “information bits.” The transmission of such information bits may include encoding the information bits into TB(s) (e.g., a TB refers to a unit of data that may be exchanged between nodes in a wireless communications system) and sending the TB(s) over a communications channel (e.g., such as a physical uplink shared channel (PUSCH), a physical downlink shared channel (PDSCH), etc.).

For example, a channel encoder (e.g., a polar encoder, a convolutional encoder, a turbo encoder, a low-density parity check (LDPC) encoder, and/or the like) may use forward error correction (FEC) to systematically add redundant bits to the information bits, such as through various coding schemes, and thereby generate encoded bits (e.g., a “codeword”) for transmission. The channel encoder may use a specific code rate to determine an amount of redundancy (e.g., redundant bits) to add to the information bits, such as to enhance the reliability of transmission of the information bits over noisy and/or error-prone communications channels. For example, a “code rate” may indicate a ratio of a number of information bits to a total number of encoded bits (e.g., including both information bits and redundant bits used for error correction) to use for transmission of the information bits

$$( e . g . , Code Rate = \frac{\# of Information Bits}{Total \# of Encoded Bits} ) .$$

The encoded bits may then be mapped to different resource elements and/or information symbols for transmission based on a modulation order. For example, a “modulation order” may indicate a number of bits (e.g., whether redundant bits and/or information bits) that can be transmitted per resource element or information symbol. After the information bits are encoded and mapped to different resource elements and/or information symbols, the information bits may be sent, e.g., as a TB, over a communications channel. A TBS of the information bit transmission may be based on the specific code rate and modulation order used to encode and transmit the information bits, as well as a number of physical resource blocks (PRBs) utilized for the transmission. A TBS may indicate how many bits are to be passed from a medium access control (MAC) layer to a physical layer in one instance of a communications channel, such as PUSCH or a PDSCH.

In certain aspects, the communication of information between a network entity and a UE may be based on an MCS. Specifically, an MCS is an index indicating a modulation order and/or a code rate to use for transmission over the air, which may help to achieve a balance between transmission data rate and reliability given current channel conditions. For example, some MCS may be associated with higher code rates (e.g., indicating to use fewer redundancy bits and more information bits for transmission) to achieve higher data rates and/or more efficient utilization of bandwidth, while some other MCS may be associated with lower code rates to allow for increased error correction capability (e.g., at a receiver of a TB) to help achieve better data reliability. Further, some MCS may be associated with higher modulation orders (e.g., indicating that a greater number of bits may be mapped to each resource element and/or information symbol) to achieve higher data rates and/or more efficient utilization of bandwidth, while some other MCS may be associated with lower modulation orders to help achieve improved signal robustness to noise, interference, and/or fading.

Various communication standards provide MCS tables that include mappings between MCS (e.g., MCS indexes) and different combinations of parameters, such as modulation order, target code rate, and/or spectral efficiency, among others. For example, the Third Generation Partnership Project (3GPP) defines several MCS tables that may be used by wireless devices (e.g., that utilize a specific radio access technology like 5G new radio (NR), long term evolution (LTE), 6G, and/or the like) to dynamically adapt their transmission settings to help optimize data transfer rates based on current network conditions. In some cases, a wireless device (e.g., a network entity) may select an appropriate MCS (e.g., MCS index) from an MCS table to use for a given communication, such that factors like data speed and reliability are balanced, taking into account the quality of the wireless signal and the potential for interference. In some cases, an MCS from an MCS table may be indicated to a wireless device (e.g., a UE) via scheduling information for a given communication, such as via a downlink control message (e.g., in DCI).

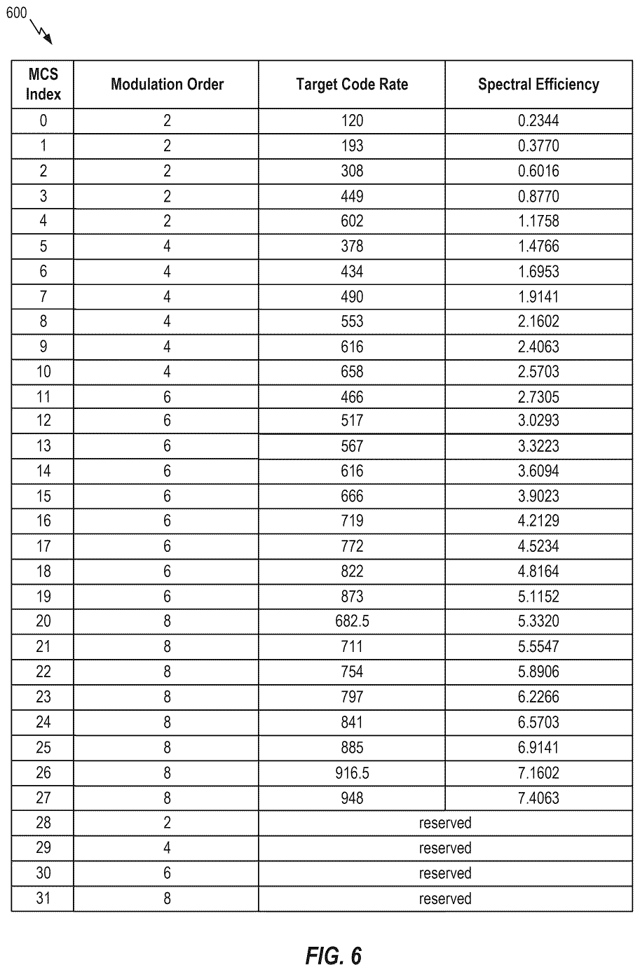

In certain aspects, an MCS table for uplink and downlink communication may include certain “reserved MCS” (also commonly referred to as “reserved MCS indexes,” “special MCS indexes,” or simply “special MCS”). FIG. 6, depicted and described below, provides one example MCS table defined by 3GPP, which includes reserved MCS. A “reserved MCS” may refer to an MCS index that is associated with only a specified (e.g., pre-defined) modulation order (e.g., a target code rate for the MCS index may not be specified, unlike other MCS index(es) in an MCS table). Reserved MCS indexes may be defined in wireless communications standards (e.g., 3GPP) for specific tasks, such as re-transmission. That is, in some cases, an initial transmission of a TB may utilize a regular MCS, in an MCS table, that is associated with a specified modulation order and code rate. If errors occur in the transmission of the TB, such as due to poor channel conditions (e.g., low signal-to-noise ratio (SNR), increased interference, etc.) and/or the transmission of a TB occurs during time period(s) where network communication is paused (e.g., UE autonomous gap(s) that are unknown by the network), a receiver of the TB may be unable to properly detect and/or decode the TB. Accordingly, the receiver may request a re-transmission of the TB. This re-transmission may utilize a reserved MCS in the MCS table. In certain aspects, the reserved MCS may correspond to a smaller modulation order than a modulation order of the regular MCS used for the initial transmission of the TB, such as to help improve the reliability of the re-transmission, even under poor channel conditions. In certain aspects, the reserved MCS may be used to preserve the TBS of the TB during re-transmission (e.g., TBS of the re-transmitted TB remains the same as the TBS of the initial transmission of the TB), while using a different modulation order and/or resource allocation than the initial transmission of the TB. For example, the reserved MCS may indicate that a TBS for the re-transmission of the TB may be based on DCI used to schedule the initial transmission of the TB.

Technical problems associated with the use of reserved MCS for TB re-transmission may occur during scenarios where DCI scheduling an initial transmission of the TB, and including a regular MCS to use for the initial transmission, is not detected and/or is unable to be decoded (e.g., is “missed”) by a receiver (e.g., a UE) of the DCI. For example, a network entity may send, to a UE, a first DCI scheduling an initial transmission (e.g., an uplink or downlink transmission) of a TB. The first DCI may include an indication of a regular MCS (e.g., a specific modulation order and code rate) associated with the initial transmission of the TB such that the UE is able to determine the TBS of the initial transmission of the TB (e.g., for decoding of the TB in the downlink or for the generation of the TB in the uplink). In this example, the UE may miss the first DCI scheduling the initial transmission of the TB and thus, fail to receive or generate the initial transmission. Accordingly, the network entity may send, to the UE, a second DCI scheduling a re-transmission (e.g., an uplink or downlink re-transmission) of the TB. The second DCI may include an indication of a reserved MCS (e.g., a specific modulation order, without specifying a code rate) associated with the re-transmission of the TB. The reserved MCS may indicate, to the UE, that a TBS of the re-transmitted TB may be based on first DCI used to schedule the initial transmission of the TB. As indicated above, the UE may fail to detect and/or decode the first DCI; thus, based on receiving the second DCI including the reserved MCS indicating to determine the TBS based on the first DCI, the UE may be unable to determine the TBS of the re-transmitted TB. Without the TBS, the UE may be unable to decode a downlink re-transmission of the TB and/or generate an uplink re-transmission of the TB (e.g., scheduled by the second DCI). Thus, resource(s) (e.g., time resource(s) and frequency resource(s)) allocated for the re-transmission of the TB may be discarded, and another DCI (e.g., a third DCI) may be sent, to the UE, to schedule another re-transmission (e.g., a second re-transmission) of the TB. This DCI may also include the include an indication of a reserved MCS; thus, resource allocation may again result. In some cases, this process of allocating and discarding resources for TB re-transmission may continue until network entity exhaustion (e.g., where the network entity is no longer able to process additional requests and/or perform additional operations, at least related to re-transmission of the TB). In such a case, the repeated scheduling (e.g., allocation) of resources for the TB re-transmission may be wasteful and/or lead to poor network resource efficiency, given the UE may never be able to determine the TBS of the re-transmitted TB, such as to enable the UE to successfully decode the TB or successfully generate the TB for re-transmission (thereby ending the need to schedule resources for TB re-transmission).

Certain aspects described herein overcome the aforementioned technical problems associated with the use of reserved MCS for TB re-transmission, and provide a technical benefit to the field of telecommunications. For example, certain aspects provide techniques for communicating TBS information associated with the re-transmission of a TB. The re-transmission of the TB may be a re-transmission that is scheduled to use a reserved MCS (e.g., for modulation and encoding), or more specifically, an MCS indicating that a TBS for the re-transmission of the TB may be based on DCI used to schedule the initial transmission of the TB. According to aspects described herein, the TBS information associated with the re-transmission of a TB may be communicated in a downlink control message (e.g., DCI) that schedules the re-transmission of the TB. For example, a new TBS field of the downlink control message may be used to convey the TBS information (e.g., one or two bits included in the TBS field) associated with the re-transmission of the TB.

In certain aspects, the TBS information included in the downlink control message may implicitly indicate the TBS of the re-transmitted TB. For example, the TBS information may indicate that the TBS of the re-transmitted TB is the same as (e.g., is equal to) a TBS value associated with a previously-decoded downlink control message. The previously-decoded downlink control message may be a last-in-time downlink control message decoded by a node (e.g., a UE) that is expected to receive the retransmission of the TB or generate and send the retransmission of the TB.

In certain aspects, the TBS information included in the downlink control message may explicitly indicate the TBS of the re-transmitted TB. For example, the TBS information may indicate that the TBS of the re-transmitted TB is equal to TBS₁ or TBS₂ (e.g., where TBS₁ or TBS₂ are different TBS values).

In certain aspects, a UE may receive a downlink control message including TBS information associated with a re-transmission of a TB and use this information to detect and decode the re-transmission of the TB (e.g., where the re-transmission of the TB is a downlink transmission). In certain aspects, a UE may receive a downlink control message including TBS information associated with a re-transmission of a TB and use this information to generate the TB according to the TBS information and send the re-transmission of the TB (e.g., where the re-transmission of the TB is an uplink transmission).

Certain techniques for communicating TBS information, for a scheduled re-transmission of a TB, described herein may provide various beneficial technical effects and/or advantages. The techniques for communicating the TBS information may enable improved wireless communications performance, such as reduced resource consumption and/or increased throughput. The reduced resource consumption and/or increased throughput may be attributable to the communication of TBS information for a TB re-transmission scheduled to use a reserved MCS for the transmission. Specifically, instead of relying on information included in a missed downlink control message, that schedules an initial transmission of the TB, for determining the TBS of the TB re-transmission, the TBS of the TB re-transmission may be determined based on the TBS information communicated using the techniques described herein. A UE may use this determined TBS to (1) successfully detect and decode the re-transmission of the TB or (2) successfully generate and send the re-transmission of the TB. Thus, multiple re-transmissions of the TB may not be needed, nor scheduled, thereby saving network resources and achieving more efficient network resource efficiency. Accordingly, resource consumption may be reduced and throughput may be increased, thereby helping to achieve a better quality of service for users.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

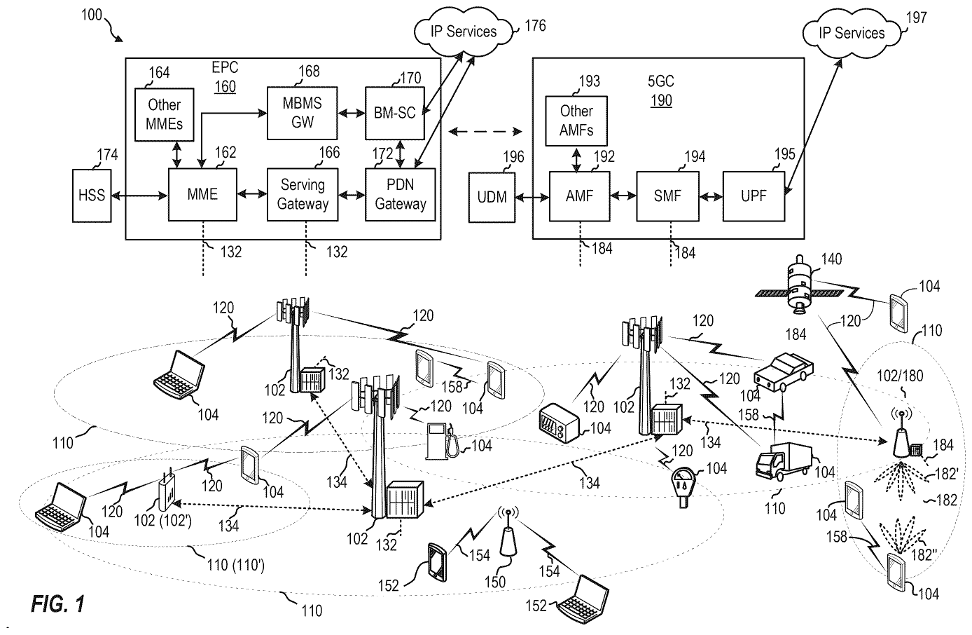

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

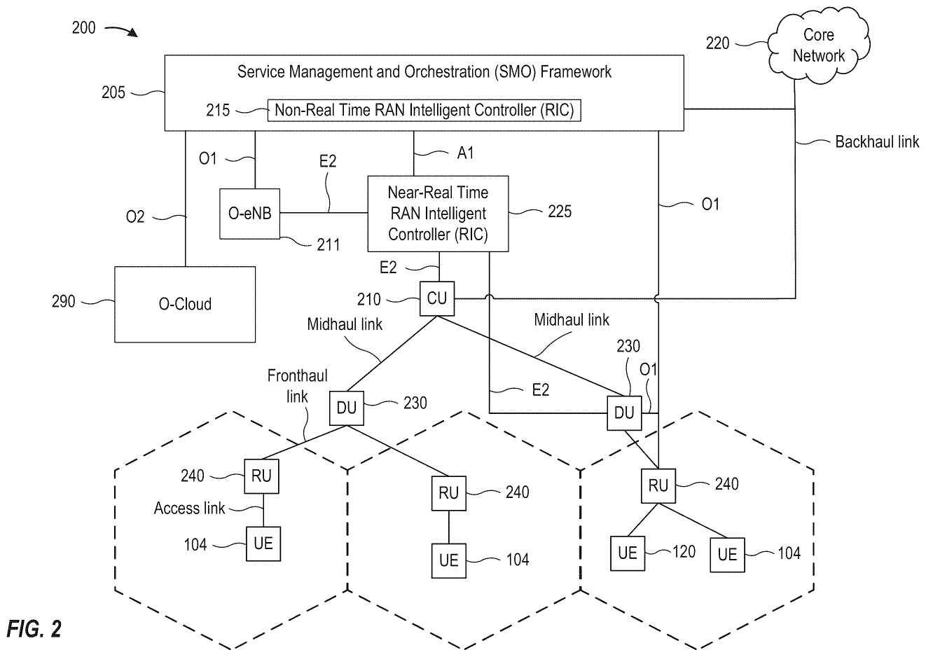

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

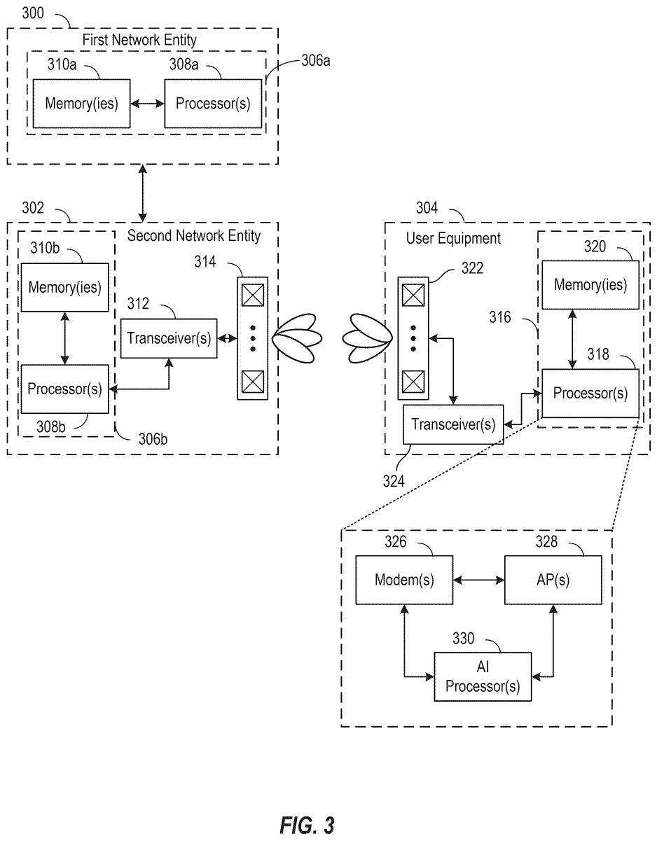

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to receive data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to receive an output sample stream. The one or more transceivers 312 may process (e.g., convert to analog, amplify, filter, and upconvert) the output sample stream to receive a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to receive input samples. The one or more transceivers 324 and/or the processing system 316 may further process the input samples to receive received symbols.

The processing system 316 (e.g., modem 326, an RX MIMO detector) may receive the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to receive a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to receive decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

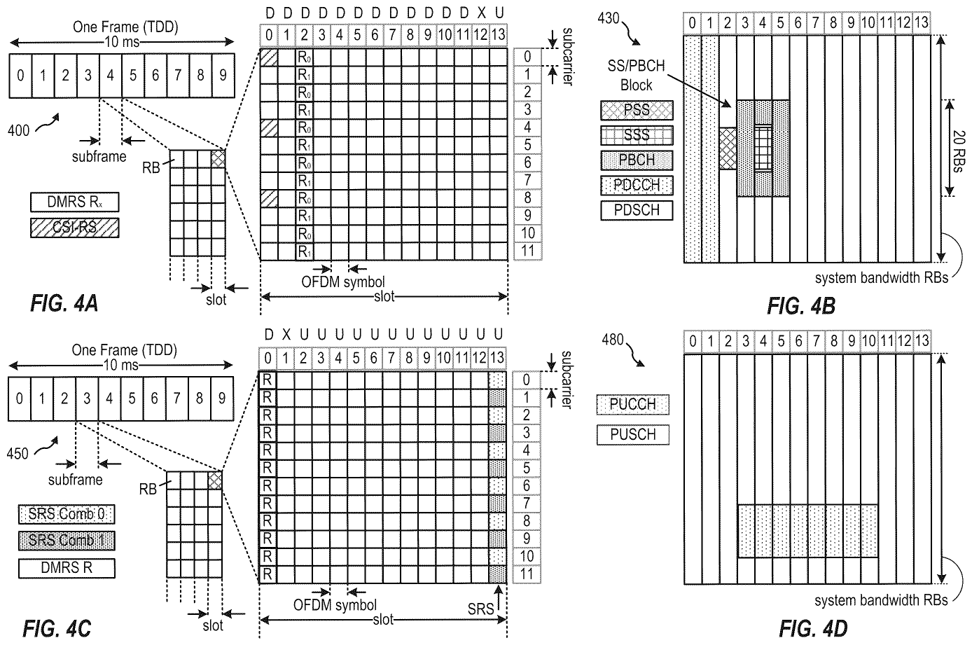

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Transmission Encoding and Modulation

In wireless communication networks (e.g., such as wireless communications network 100 of FIG. 1), information may be represented as a sequence of binary bits (e.g., the smallest unit of information on a machine). For transmission of such information, the binary bits may be mapped (e.g., modulated) to analog signal waveforms and transmitted over a communications channel (e.g., such as a PUSCH, PDSCH, etc.). During propagation via a wireless channel, the transmitted signal may incur noise and/or interference that corrupts the transmitted signal. Accordingly, in certain aspects, prior to transmission of the signal, channel coding may be used to add redundant bits to the information bits for transmission, such as to protect the transmitted information bits from channel noise and/or interference, and thereby, enhance communication reliability.

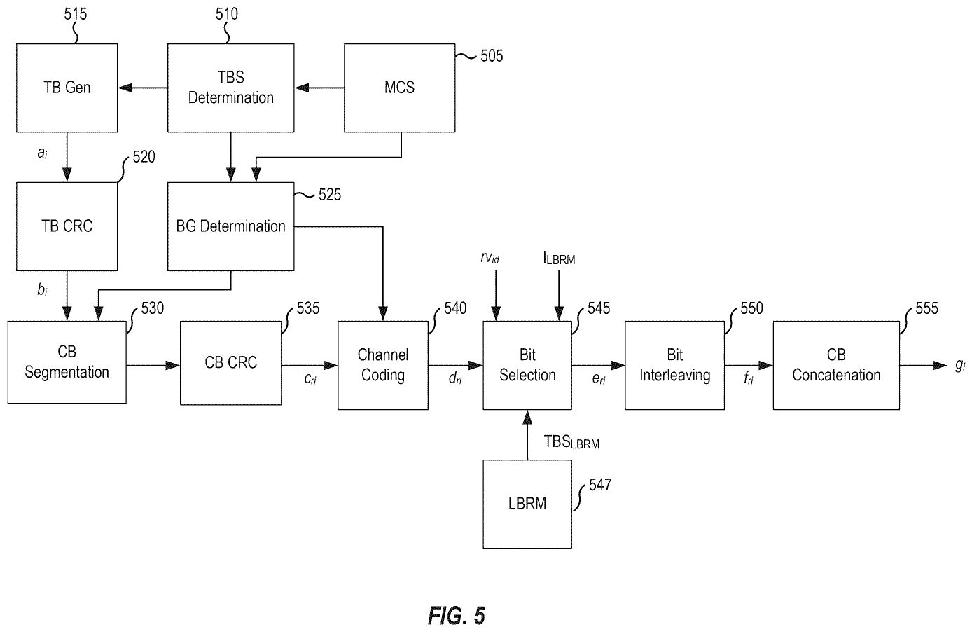

FIG. 5 is a diagram 500 depicting an example of a transmission coding chain. The depicted transmission coding chain comprises a sequence of steps involved in the process of applying “channel coding” (e.g., also simply referred to herein as “coding”) to data, including encoding and decoding operations, which may help to achieve reliable transmission of the data over a wireless communications network (e.g., such as wireless communications network 100 of FIG. 1). The example coding chain of FIG. 5 is one example of a coding chain. It is noted that some devices may use a coding chain that omits or modifies one or more blocks of the transmission coding chain illustrated in FIG. 5.

The coding may be used for the transmission of data payloads in the wireless communications network, such as via a PUSCH or a PDSCH. The operations of FIG. 5 may be performed by a transmitter, such as a UE (e.g., such as UE 104 of FIG. 1 or UE 304 of FIG. 3) for uplink communications or a network entity (e.g., such as BS 102 of FIG. 1, a first network entity 300 or second network entity 302 of FIG. 3, or a disaggregated base station as discussed with respect to FIG. 2) for downlink communications.

The coding chain may be based at least in part on an MCS, which is shown at 505. An MCS is an index indicating a modulation order and a code rate for a communication. For example, an MCS may indicate how many bits can be transmitted per resource element or information symbol. A modulation indicates a number of bits (e.g., whether parity bits (e.g., redundant bits) and/or information bits (e.g., data bits)) per resource element or information symbol. A code rate indicates a ratio of the number of information bits to the total number of transmitted bits (e.g., including both information bits and redundant bits used for error correction) in a transmission. The MCS may be indicated via scheduling information for a given communication, such as in DCI.

At 510, the transmitter may determine a TBS based at least in part on the MCS. A TBS may indicate how many bits are to be passed from a MAC layer to a physical layer in one instance of a channel, such as an uplink shared channel transmission. For example, the payload for the physical layer (e.g., such as in a PUSCH or a PDSCH) may include a TB. The TB may include a number of bits, determined based at least in part on the MCS and a number of PRBs to be used to transmit the TB.

At 515, the transmitter may generate a TB ai. For example, the TB may include a number of bits indicated by the TBS of the TB. At 520, the transmitter may use a cyclic redundancy check (CRC) algorithm to generate a checksum, which is a fixed-size value based on the encoded data being transmitted, and append this checksum to the TB to form a TB bi. For example, the checksum may be generated using a cyclic generator polynomial and may be appended to an end of the TB ai to form the TB bi. The checksum appended to the TB may aid in error detection. For example, the checksum may be checked by a receiver to detect any errors during transmission.

At 525, the transmitter may determine a base graph (BG) for the TB bi. A BG is a parameter for determining parity bits for a transmission based at least in part on a TBS and a code rate (e.g., with BG1 being intended for TBs with a larger TBS, and BG2 being intended for TBs with a smaller TBS).

At 530, the transmitter may perform codeblock (CB) segmentation for the TB bi. “CB segmentation” may refer to segmentation of the TB bi to form one or more CBs for channel coding and rate matching. Each CB may be encoded separately, as described below. For example, the steps shown by reference numbers 535 through 550 may be performed for each separate CB of the one or more CBs. At 535, the transmitter may append one or more checksums (e.g., generated via a CRC algorithm) to the one or more CBs to form CB(s) cᵣᵢ. For example, the transmitter may perform per-CB CRC to generate and append checksums on the one or more CBs cᵣᵢ, which may help to aid in early error detection.

At 540, the transmitter may perform channel coding on the one or more codeblocks cᵣᵢ to form encoded bits dᵣᵢ. In certain aspects, the channel coding may be performed according to one or more parameters of the BG determined at 520. This channel coding may add redundancy (e.g., redundant bits to the payload), allowing a receiver to detect and correct errors that may occur during transmission. Example types of error correcting codes used for channel coding include, but are not limited to, block codes (e.g., Hamming codes, Reed-Solomon codes, etc.), convolutional codes (e.g., turbo codes, Viterbi algorithms, etc.), LDPC codes, and polar codes. For example, in certain aspects, channel coding may include performing LDPC encoding on the one or more CBs cᵣᵢ to generate a plurality of encoded bits dᵣᵢ. In certain aspects, the encoded bits may be referred to as an encoded CB. The encoded bits dᵣᵢ are distinct from the CBs cᵣᵢ. In certain aspects, the encoded bits dᵣᵢ are stored in a circular buffer.

At 545, the transmitter may perform bit selection. “Bit selection” refers to selecting coded bits eᵣᵢ (e.g., also commonly referred to as “encoded bits eᵣᵢ”) from the encoded bits dᵣᵢ for bit interleaving 550 and CB concatenation 555. In certain aspects, bit selection is performed using limited buffer rate matching (LBRM) 547. LBRM 547 is a bit selection technique that limits a number of bits that are selected based on a limited buffer size. For example, in the context of error-correcting codes, “rate matching” refers to the process of adapting the rate of encoded data to fit the available channel capacity. LBRM 547 is helpful in situations where the buffer (or memory) used to temporarily store data is constrained in size, and it becomes necessary to manage this limitation effectively.

In certain aspects, bit selection may be based at least in part on an LBRM index (I_{LBRM}) or an LBRM transport block size (TBS_{LBRM}). In certain aspects, bit selection may be based at least in part on a redundancy version (RV) index (rv_{id}).

The transmitter may select a number of coded bits per CB cᵣᵢ. At 550, the transmitter may perform interleaving to generate one or more interleaved encoded bit sequences fᵣᵢ. Interleaving may be performed on a per-CB basis (e.g., for each CB cᵣᵢ). In certain aspects, “interleaving” may be referred to as “channel interleaving.” In certain aspects, the transmitter may perform row-column interleaving. In row-column interleaving, selected coded bits may be arranged into a number of rows corresponding to the modulation order. Then, selected bits may be read column-by-column, such that bits from each row are interleaved with each other.

At 555, the transmitter may perform CB concatenation on the encoded bit sequences fᵣᵢ to generate a CB gᵢ (e.g., which is distinct from the CB(s) cᵣᵢ).

After the CB gᵢ has been generated, the transmitter may transmit the CB gᵢ. For example, the transmitter may perform scrambling, modulation, layer mapping, antenna port mapping, mapping to one or more virtual resource blocks, and/or mapping from virtual resource blocks to physical resource blocks. Then, the transmitter may transmit a communication carrying an encoded TB, which is based at least in part on the CB gᵢ.

A receiver may receive the communication carrying the encoded TB over the time and frequency resources assigned for this transmission occasion. The receiver may estimate the channel using one or more demodulation reference signals (DMRSs) transmitted along with the encoded bits. Using the estimated channel and the received signal, the receiver performs the demapping operation on each resource element of the received signal to receive soft information regarding the bit values of the encoded TB. Soft information may take the form of a log-likelihood ratio (such as a probability, based on the received signal, that a transmitted bit is a 0 or a 1). This probability may be quantized to a few levels (for example, 16 or 32 levels). In the extreme case that the probability is quantized to 2 levels, the soft information may degenerate to “hard” information. For example, a two-level quantization of the probability may represent the receiver's best estimation as to what the transmitted bit was, with no further nuance on this guess.

The receiver may perform de-interleaving on the soft information to receive de-interleaved soft information. The receiver may concatenate the de-interleaved soft information to receive concatenated soft information. For example, the receiver may concatenate the de-interleaved soft information based at least in part on starting locations for each of multiple slots, which may be analogous to the start locations in the circular buffer for bit selection, as described elsewhere herein. The receiver may decode the concatenated soft information to infer one or more CBs of the communication.

Various communication standards provide MCS tables that include mappings between MCS (e.g., MCS indexes) and different combinations of parameters, such as modulation order, target code rate, and/or spectral efficiency, which may be used for transmission encoding and modulation (e.g., described in detail above with respect to FIG. 5).

For example, 3GPP defines several MCS tables that may be used by wireless devices to dynamically adapt their transmission settings for uplink and/or downlink communications. In certain aspects, these MCS tables may include (2) “regular MCS” (also referred to as “regular MCS indexes” or simply “MCS” or “MCS indexes”) and (2) “reserved MCS” (also commonly referred to as “reserved MCS indexes,” “special MCS indexes,” or simply “special MCS”). A “regular MCS” may refer to an MCS index that is associated with a specific (e.g., pre-defined) modulation order and a specific (e.g., pre-defined) code rate. A “reserved MCS” may refer to an MCS index that is associated with only a specified (e.g., pre-defined) modulation order (e.g., a target code rate for the MCS index may not be specified, unlike other MCS index(es) in an MCS table).

FIG. 6 depicts an example MCS table 600 defined by 3GPP, which includes regular and reserved MCS. As shown in FIG. 6, the regular MCS include MCS indexes 0-27, while the reserved MCS include MCS indexes 28-31.

Reserved MCS may be defined in wireless communications standards (e.g., 3GPP) for specific tasks, such as re-transmission. That is, an initial transmission of a TB may utilize an MCS, in an MCS table, that is associated with a specified modulation order and code rate. In some cases, error may occur in the transmission of the TB due to poor channel conditions, including channel conditions with very low PDCCH aggregation levels. In some cases, errors may occur in the transmission of the TB due to the transmission of TB during time period(s) where network communication is paused (e.g., UE autonomous gap(s) that are unknown by the network and result in a lack of scheduling coherency between the UE and the network, which may include UE channel reservation and allocation time (CRAT) gaps, multiple SIM (MSIM) gaps, missing a secondary cell group (SCC) activation action slot, etc.). If errors occur in the transmission of the TB, a receiver of the TB may be unable to properly detect and/or decode the TB, and thereby may request a re-transmission of the TB. This re-transmission may utilize a reserved MCS in the MCS table. In certain aspects, the reserved MCS may be used to preserve the TBS of the TB during re-transmission (e.g., TBS of the re-transmitted TB remains the same as the TBS of the initial transmission of the TB), while using a different modulation order and/or resource allocation than the initial transmission of the TB. For example, the reserved MCS may indicate that a TBS for the re-transmission of the TB may be based on DCI used to schedule the initial transmission of the TB.

In certain aspects, determining the TBS for the re-transmission of the TB based on the DCI used to schedule the initial transmission of the TB may not be possible, such as in a case where an intended receiver of the DCI used to schedule the initial transmission of the TB never receives the DCI (e.g., due to poor channel conditions, due to the transmission of the DCI during a UE autonomous gap, etc.). Without the TBS, the receiver may be unable to decode a re-transmission of the TB and thus may discard resources scheduled for the re-transmission of the TB. The receiver may provide NACK feedback related to the re-transmission of the TB which may again trigger another re-transmission of the TB. This cycle of scheduling subsequent TB re-transmission and discarding resources scheduled for the subsequent TB re-transmission may repeat over and over again, at least until transmitter exhaustion is realized. This repeated scheduling (e.g., allocation) of resources for each TB re-transmission may be wasteful and, in some cases, may lead to poor network resource efficiency.

### Aspects Related to TBS Information Communication for TB Re-Transmission

Aspects described herein improve upon the state of the art by providing techniques for communicating TBS information for a TB scheduled to be re-transmitted according to a reserved MCS. For example, TBS information for the re-transmission of the TB may be included in a downlink control message (e.g., DCI) that schedules the re-transmission of the TB. In certain aspects, the TBS information included in the downlink control message may implicitly indicate the TBS of the re-transmitted TB. For example, the TBS information may indicate that the TBS of the re-transmitted TB is the same as (e.g., is equal to) a TBS value from a previously-decoded downlink control message. In certain aspects, the TBS information included in the downlink control message may explicitly indicate the TBS of the re-transmitted TB. For example, the TBS information may indicate that the TBS of the re-transmitted TB is equal to a first TBS, TBS₁, or a second TBS, TBS₂ (e.g., where TBS₁ or TBS₂ are different TBS values).

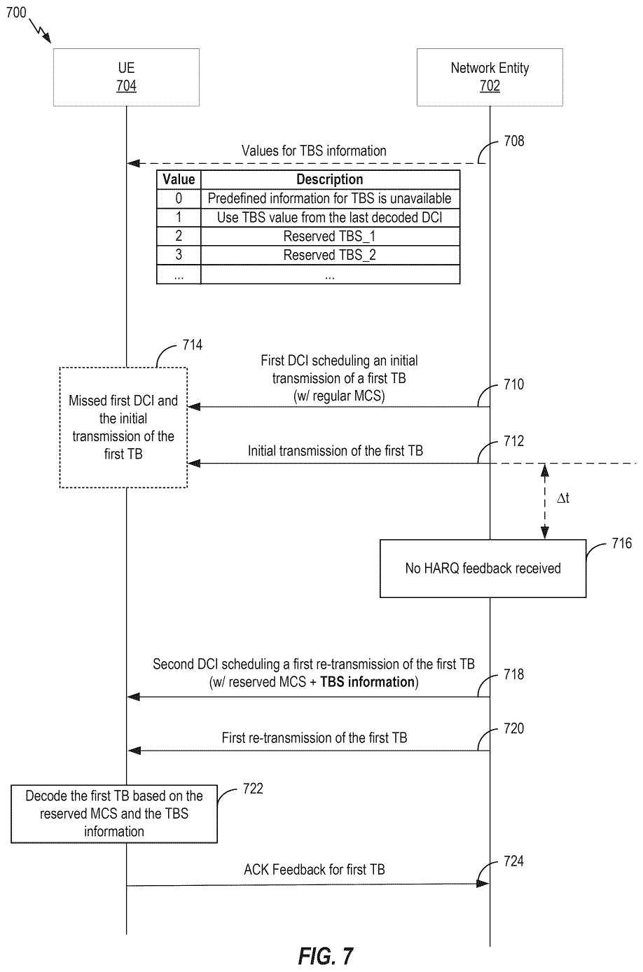

In certain aspects, the re-transmission of the TB, scheduled by the downlink control message, may comprise a downlink transmission sent from a network entity to a UE. Thus, a UE receiving the downlink control message may use the TBS information included in the downlink control message to detect and decode the re-transmitted TB. This scenario is depicted and described with respect to FIG. 7 below.

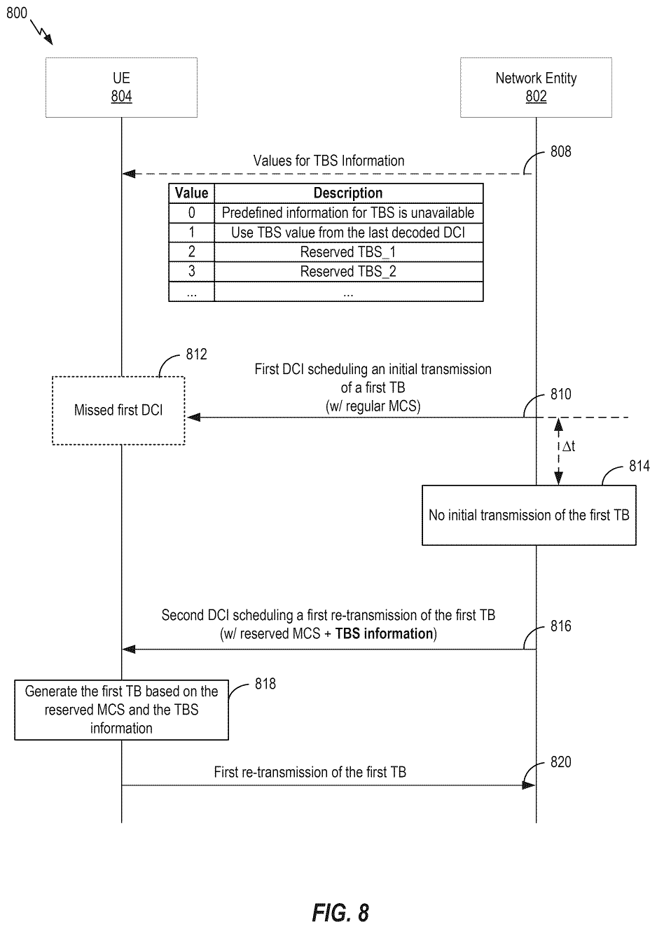

In certain aspects, the re-transmission of the TB, scheduled by the downlink control message, may comprise an uplink transmission sent from a UE to a network entity. Thus, a UE receiving the downlink control message may use the TBS information included in the downlink control message to generate the TB such that the TB may be re-transmitted using one or more resources scheduled to be used for the re-transmission of the TB (e.g., scheduled via the downlink control message). This scenario is depicted and described with respect to FIG. 8 below.

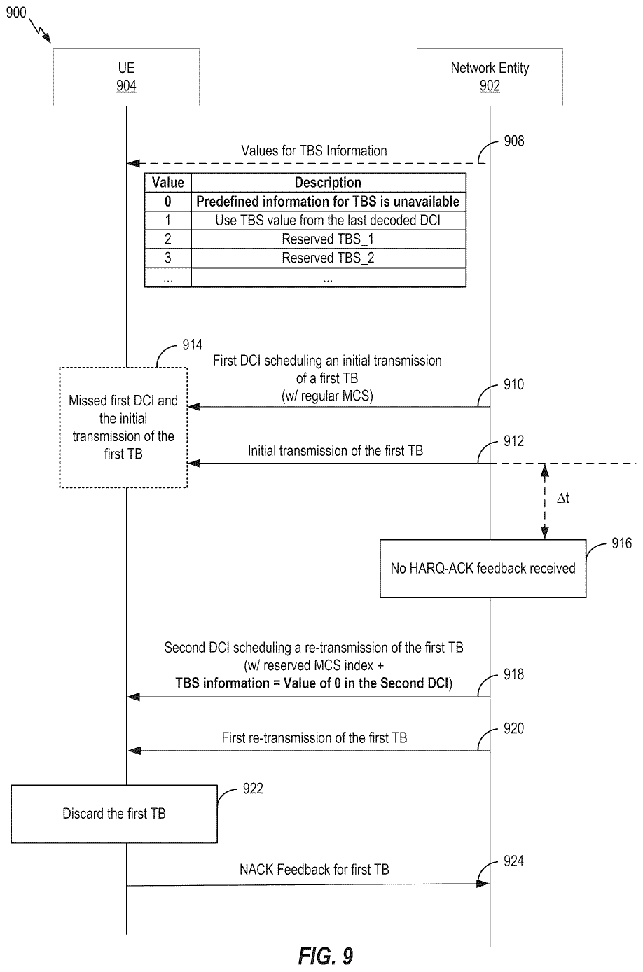

In certain aspects, the TBS information, included in a downlink control message from a network entity to a UE, may indicate that TBS information for a re-transmission of a TB (e.g., scheduled by the downlink control message) is unavailable. Additional details related to this signaling is depicted and described below with respect to FIG. 9.

### Example Signaling to Communicate TBS Information

FIG. 7 depicts a process flow 700 for communications in a network between a network entity 702 and a UE 704. In certain aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

Process flow 700 optionally begins at 708 with network entity 702 sending, and UE 704 receiving, signaling indicating (1) one or more values (e.g., indexes) for TBS information and (2) one or more indications of TBS, where each indication of TBS is associated with one of the TBS information values. For example, as shown in FIG. 7, UE may receive signaling indicating multiple values (e.g., at least four values of “0,” “1,” “2,” and “3”) for TBS information, which may be included in DCI (e.g., scheduling a re-transmission of a TB). The signaling may further provide an indication of a TBS associated with each of the multiple values. In particular, a TBS information value of “O” may be associated with a TBS indication indicating that predefined TBS information for a re-transmission of a TB is unavailable. A TBS information value of “1” may be associated with a TBS indication indicating that a TBS for a re-transmission of a TB is based on a TBS from a last (e.g., in time) decoded DCI. A TBS information value of “2” may be associated with a TBS indication explicitly indicating that a TBS for a re-transmission of a TB is equal to a first TBS, TBS₁. A TBS information value of “3” may be associated with a TBS indication explicitly indicating that a TBS for a re-transmission of a TB is equal to a second TBS, TBS₂.

As described, TBS information values (shown in the table in FIG. 7) may be included in DCI, such as in a TBS field of the DCI. In certain aspects, a bitwidth of the TBS field in the DCI may be determined as log ₂I, where variable I represents a number of entries in high layer parameter “pdsch/pusch-TransportBlockListDCI_x_x.” For example, where signaling sent to UE 704, at 708, includes two TBS information values, then the bitwidth may be determined as ceil(log ₂(2))=1 bit. As another example, where signaling sent to UE 704, at 708, includes four TBS information values, then the bitwidth may be determined as ceil(log ₂(4))=2 bits. As another example, where signaling sent to UE 704, at 708, includes six TBS information values, then the bitwidth may be determined as ceil(log ₂(6))=3 bits.

Although in this example, the signaling, sent from network entity 702 to UE 704 at 708, may indicate four TBS information values, and their corresponding TBS indications, in some other examples, the signaling may indicate more or less TBS information values and their corresponding TBS indications, and the TBS indication associated with each TBS information value may be the same and/or different.

Further, although in this example signaling is sent at 708, between network entity 702 and UE 704, to indicate to UE 704 different TBS information values that may be included in DCI, and their corresponding TBS indications, in some other examples, this information may be defined in wireless communications standards (e.g., 3GPP).

At 710, network entity 702 sends, to UE 704, a first DCI scheduling an initial transmission of a first TB. The initial transmission of the first TB, scheduled by the first DCI, may be a downlink communication, such as via a PDSCH between network entity 702 and UE 704. Scheduling information for the initial transmission of the first TB, included in the first DCI, may include an indication of a regular MCS (e.g., a regular MCS index). The regular MCS may be associated with a specific modulation order and a specific code rate that may be used for decoding the initial transmission of the first TB (e.g., as described above with respect to FIGS. 5 and 6). For example, the network entity 702 may use the specific modulation order and code rate, associated with the indicated regular MCS, to generate the first TB and send the initial transmission of the first TB to the UE 704. Further, the UE 704 may use the specific modulation order and code rate, associated with the indicated regular MCS, to decode the initial transmission of the first TB, when detected.

Accordingly, at 712, network entity 702 sends the initial transmission of the first TB. For example, network entity 702 may use one or more resources scheduled for the initial transmission of the first TB by the first DCI to send the initial transmission of the first TB to UE 704. The first TB may have a TBS that is based on the modulation order and the code rate of the regular MCS indicated in the first DCI.

As shown at 714 in FIG. 7, UE 704 may miss (e.g., fail to detect and/or decode) the transmission of the first DCI from network entity 702, and further the initial transmission of the first TB from network entity 702. Accordingly, at least because UE 704 does not have information that the initial transmission of the first TB has been scheduled, UE 704 may not send, to network entity 702, any HARQ feedback (e.g., acknowledgement (ACK) feedback or NACK feedback) for the initial transmission of the first TB.

After a period of time (e.g., shown as Δt in FIG. 7) has passed after the initial transmission of the first TB at 712, network entity 702 may determine, at 716, that no HARQ feedback has been received for first TB, and thus stop monitoring for such feedback. In certain aspects, the period of time, Δt, may be equal to K1, which refers to the expected offset between a downlink slot where data is scheduled and an uplink slot where HARQ feedback for the downlink data is expected to be sent. In this example, K1 may be equal to the expected time offset between a slot where the initial transmission of the first TB is sent to UE 704 and a slot where HARQ feedback is expected to be sent for the initial transmission of the first TB.

Upon making this determination at 716, network entity 702 may determine to re-transmit the first TB to UE 704. Accordingly, at 718, network entity 702 sends, and UE 704 receives, a second DCI scheduling a first re-transmission of the first TB. The first re-transmission of the first TB, scheduled by the second DCI, may be another downlink communication, such as via the PDSCH between network entity 702 and UE 704. Scheduling information for the first re-transmission of the first TB, included in the second DCI, may include an indication of a reserved MCS (e.g., a reserved MCS index). The reserved MCS may be associated with a specific modulation order that may be used for decoding the first re-transmission. Further, the indication of the reserved MCS in the second DCI may indicate, to UE 704, to determine a TBS for the re-transmission of the first TB based on the first DCI used to schedule the initial transmission of the first TB (e.g., sent from network entity 702 to UE 704 at 710).

Because UE 704 failed to detect and decode the first DCI, sent to UE 704 at 710, determining the TBS for the re-transmission of the first TB based on the first DCI may not be possible. Instead, according to aspects described herein, UE 704 may utilize TBS information included in the second DCI sent to UE 704, from network entity 702, at 718.

For example, in addition to including an indication of the reserved MCS, the second DCI may also include TBS information for the re-transmission of the first TB. In certain aspects, the TBS information may be included as one or more bits (e.g., one or two bits) in a TBS field of the second DCI. In certain aspects, the TBS information may be set to one of the TBS information values, such as optionally provided to UE 704 at 708 or defined in wireless communication standards.

For example, in some cases, the TBS information may be set to a TBS information value of “1” (e.g., the second DCI may include TBS information value “1”). The TBS information being set to the TBS information value of “1” may indicate that the TBS for the first re-transmission of the first TB is based on a TBS value from a last (e.g., in time) DCI that was decoded by UE 704 (e.g., a DCI sent prior to when the first DCI was sent by network entity 702, to UE 704, at 708). In certain aspects, the TBS information may be set to a TBS information value of “1” for voice calls and/or for maximum throughput scenarios where TBS is rarely changed.

As another example, the TBS information may be set to a TBS information value of “2” (e.g., the second DCI may include TBS information value “2”). The TBS information being set to the TBS information value of “2” may indicate that the TBS for the first re-transmission of the first TB is equal to a first TBS, TBS₁.

As another example, the TBS information may be set to a TBS information value of “3” (e.g., the second DCI may include TBS information value “3”). The TBS information being set to the TBS information value of “2” may indicate that the TBS for the first re-transmission of the first TB is equal to a second TBS, TBS₂.

In certain aspects, the TBS information may be set to a TBS information value of “2” or TBS information value “3” when a status of UE 704 is unclear to network entity 702 (e.g., one or more of these TBS information values may be use as fallback value(s) by network entity 702).

At 720, network entity 702 sends, to UE 704, the first re-transmission of the first TB. For example, network entity 702 may use one or more resources scheduled for the first re-transmission of the first TB by the second DCI to send the first re-transmission of the first TB to UE 704. The first TB (e.g., sent as the first re-transmission) may have a TBS that is based on (1) the modulation order of the reserved MCS indicated in the second DCI and (2) the TBS information indicated in the second DCI.

Based on receiving (e.g., detecting and decoding) the second DCI, UE 704 may monitor for the first re-transmission of the first TB. At 720, based on the monitoring, UE 704 detects the first re-transmission of the first TB.

At 722, UE 704 decodes the first TB based on the reserved MCS and the TBS information included in the second DCI (e.g., sent to and obtained by UE 704 at 718). For example, UE 704 may determine the TBS for the first TB based on the reserved MCS and the TBS information included in the second DCI and use this TBS to decode the re-transmission of the first TB. Assuming the UE 704 is able to successfully decode the first TB, at 724, UE 704 sends, to network entity 702, ACK feedback for the first TB. The ACK feedback may serve as feedback to network entity 702, indicating that network entity 702 may proceed with transmitting a next data packet (e.g., a second TB), as the first TB has been successfully received and decoded by UE 704.

Note that the process flow 700 illustrated in FIG. 7 is described herein to facilitate an understanding of TBS information communication, and aspects of the present disclosure may be performed in various manners via alternative or additional signaling and/or operations. In certain aspects, the operations and/or signaling of FIG. 7 may occur in an order different from that described or depicted, and various actions, operations, and/or signaling may be added, omitted, or combined.

Different from FIG. 7 where TBS information is included in DCI scheduling a re-transmission of a TB in the downlink, in FIG. 8, TBS information may instead be included in DCI scheduling a re-transmission of a TB in the uplink.

For example, FIG. 8 depicts a process flow 800 for communications in a network between a network entity 802 and a UE 804. In certain aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

Similar to process flow 700, process flow 800 may optionally begin, at 808, with network entity 802 sending, and UE 804 receiving, signaling indicating (1) one or more values for TBS information and (2) one or more indications of TBS, where each indication of TBS is associated with one of the TBS information values.

At 810, network entity 802 sends, to UE 804, a first DCI scheduling an initial transmission of a first TB. The initial transmission of the first TB, scheduled by the first DCI, may be an uplink communication, such as via a PUSCH between UE 804 and network entity 802. Scheduling information for the initial transmission of the first TB, included in the first DCI, may include an indication of a regular MCS (e.g., a regular MCS index). The regular MCS may be associated with a specific modulation order and a specific code rate that may be used for generating the first TB (e.g., as described above with respect to FIGS. 5 and 6) for the initial transmission of the first TB. For example, the UE 804 may use the specific modulation order and code rate, associated with the indicated regular MCS, to generate the first TB and send the initial transmission of the first TB to the network entity 802. Further, the network entity 802 may use the specific modulation order and code rate, associated with the indicated regular MCS, to decode the initial transmission of the TB, when detected.

In this example, however, UE 804 may miss (e.g., fail to detect and decode) the first DCI, sent from network entity 802 at 810. Accordingly, at 812, UE 804 may determine that UE 804 has missed the first DCI. Based on this determination, UE 804 may not generate the first TB, and further, may not send the initial transmission of the first TB to UE 804. For example, at least because UE 804 does not have information of the initial transmission of the first TB scheduled by the first DCI, UE 804 may not send, to network entity 802, the initial transmission of the first TB.

After a period of time (e.g., shown as Δt in FIG. 8) has passed after sending, at 810, the first DCI to UE 804, network entity 802 may determine, at 814, that no initial transmission of the first TB may be sent by UE 804. Thus, network entity 802 may stop monitoring for the initial transmission of the first TB from UE 804. In certain aspects, the period of time, Δt, may be equal to K2, which refers to the expected offset between a downlink slot where DCI for uplink scheduling is received and an uplink slot where the scheduled uplink data is expected to be sent. In this example, K2 may be equal to the expected time offset between a slot where the first DCI scheduling the initial transmission of the first TB is sent to UE 704 and a slot where the initial transmission of the first TB is expected to be sent.

Upon making this determination at 814, network entity 802 may determine to schedule a re-transmission of the first TB. Accordingly, at 816, network entity 802 sends, and UE 804 receives, a second DCI scheduling a first re-transmission of the first TB. The first re-transmission of the first TB, scheduled by the second DCI, may be another uplink communication, such as via the PUSCH between UE 804 and network entity 802. Scheduling information for first re-transmission of the first TB, included in the second DCI, may include an indication of a reserved MCS (e.g., a reserved MCS index). The reserved MCS may be associated with a specific modulation order that may be used for generating the first TB for the first re-transmission. Further, the indication of the reserved MCS in the second DCI may indicate, to UE 804, to determine a TBS for the re-transmission of the first TB based on the first DCI used to schedule the initial transmission of the first TB (e.g., sent from network entity 802 to UE 804 at 810).

Because UE 804 failed to detect and decode the first DCI, sent to UE 804 at 810, determining the TBS for the re-transmission of the first TB based on the first DCI may not be possible. Instead, according to aspects described herein, UE 804 may utilize TBS information included in the second DCI sent to UE 804, from network entity 802, at 816.

For example, in addition to including an indication of the reserved MCS, the second DCI may also include TBS information for the re-transmission of the first TB. In certain aspects, the TBS information may be included as one or more bits (e.g., one or two bits) in a TBS field of the second DCI. In certain aspects, the TBS information may be set to one of the TBS information values, such as optionally provided to UE 704 at 708 or defined in wireless communication standards.

At 818, UE 804 generates the first TB for the first re-transmission. UE 804 may generate the first TB to have a TBS that is based on (1) the modulation order of the reserved MCS indicated in the second DCI and (2) the TBS information indicated in the second DCI.

At 820, UE 804 sends, to network entity 802, the first re-transmission of the first TB. For example, network entity 702 may use one or more resources scheduled for the first re-transmission of the first TB by the second DCI to send the first re-transmission of the first TB to network entity 802. Network entity 802 may monitor for, detect, and decode the first re-transmission of the first TB. In certain aspects, network entity 802 determines the TBS for the TB based on (1) the modulation order of the reserved MCS indicated in the second DCI and (2) the TBS information indicated in the second DCI. The TBS may be used by network entity 802 to decode the first re-transmission of the first TB.

Note that the process flow 800 illustrated in FIG. 8 is described herein to facilitate an understanding of TBS information communication, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

Different from FIG. 8 where TBS information is included in DCI scheduling a re-transmission of a TB in the uplink, in FIG. 9, TBS information may instead be included in DCI scheduling a re-transmission of a TB in the downlink (e.g., similar to FIG. 7). However, different from FIG. 7, the TBS information included in the DCI scheduling the re-transmission of the TB int the downlink may indicate that TBS information for the re-transmission of the TB is unavailable.

For example, FIG. 9 depicts a process flow 900 for communications in a network between a network entity 902 and a UE 904. In certain aspects, the network entity 902 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 904 may be an example of UE 104 depicted and described with respect to FIG. 1 or the UE 304 depicted and described with respect to FIG. 3. However, in other aspects, UE 904 may be another type of wireless communications device and network entity 902 may be another type of network entity or network node, such as those described herein. Note that any operations or signaling illustrated with dashed lines may indicate that that operation or signaling is an optional or alternative example.

Similar to process flow 700, process flow 900 may optionally begin, at 908, with network entity 902 sending, and UE 904 obtaining, signaling indicating (1) one or more values for TBS information and (2) one or more indications of TBS, where each indication of TBS is associated with one of the TBS information values.

At 910, network entity 902 sends, to UE 904, a first DCI scheduling an initial transmission of a first TB. The initial transmission of the first TB, scheduled by the first DCI, may be a downlink communication, such as via a PDSCH between network entity 902 and UE 904. Scheduling information for the initial transmission of the first TB, included in the first DCI, may include an indication of a regular MCS (e.g., a regular MCS index). The regular MCS may be associated with a specific modulation order and a specific code rate that may be used for decoding the initial transmission of the first TB (e.g., as described above with respect to FIGS. 5 and 6). For example, the network entity 902 may use the specific modulation order and code rate, associated with the indicated regular MCS, to generate the first TB and send the initial transmission of the first TB to the UE 904. Further, the UE 904 may use the specific modulation order and code rate, associated with the indicated regular MCS, to decode the initial transmission of the first TB, when detected.

Accordingly, at 912, network entity 902 sends the initial transmission of the first TB. For example, network entity 902 may use one or more resources scheduled for the initial transmission of the first TB by the first DCI to send the initial transmission of the first TB to UE 904. The first TB may have a TBS that is based on the modulation order and the code rate of the regular MCS indicated in the first DCI.

As shown at 914 in FIG. 9, UE 904 may miss (e.g., fail to detect and/or decode) the transmission of the first DCI from network entity 902, and further the initial transmission of the first TB from network entity 902. Accordingly, at least because UE 904 does not have information that the initial transmission of the first TB has been scheduled, UE 904 may not send, to network entity 902, any HARQ feedback (e.g., ACK feedback or NACK feedback) for the initial transmission of the first TB.

After a period of time (e.g., shown as Δt in FIG. 9) has passed after the initial transmission of the first TB at 912, network entity 902 may determine, at 916, that no HARQ feedback has been received for first TB, and thus stop monitoring for such feedback. In certain aspects, the period of time, Δt may be equal to K1. In this example, K1 may be equal to the expected time offset between a slot where the initial transmission of the first TB is sent to UE 904 and a slot where HARQ feedback is expected to be sent for the initial transmission of the first TB.

Upon making this determination at 916, network entity 902 may determine to re-transmit the first TB to UE 904. Accordingly, at 918, network entity 902 sends, and UE 904 obtains, a second DCI scheduling a first re-transmission of the first TB. The first re-transmission of the first TB, scheduled by the second DCI, may be another downlink communication, such as via the PDSCH between network entity 902 and UE 904. Scheduling information for first re-transmission of the first TB, included in the second DCI, may include an indication of a reserved MCS (e.g., a reserved MCS index). The reserved MCS may be associated with a specific modulation order that may be used for decoding the first re-transmission. Further, the indication of the reserved MCS in the second DCI may indicate, to UE 904, to determine a TBS for the re-transmission of the first TB based on the first DCI used to schedule the initial transmission of the first TB (e.g., sent from network entity 902 to UE 904 at 910).

Because UE 904 failed to detect and decode the first DCI, sent to UE 904 at 910, determining the TBS for the re-transmission of the first TB based on the first DCI may not be possible. Instead, according to aspects described herein, UE 904 may utilize TBS information included in the second DCI sent to UE 904, from network entity 902, at 918.

For example, in addition to including an indication of the reserved MCS, the second DCI may also include TBS information for the re-transmission of the first TB. In certain aspects, the TBS information may be included as one or more bits (e.g., one or two bits) in a TBS field of the second DCI. In certain aspects, the TBS information may be set to one of the TBS information values, optionally provided to UE 904 at 908 or defined in wireless communication standards.

In this example, the TBS information may be set to a TBS information value of “0” (e.g., the second DCI may include TBS information value “0”). The TBS information being set to the TBS information value of “O” may indicate that the TBS for the first re-transmission of the first TB is not available.

Without this TBS information, UE 904 may be unable to determine the TBS for the first re-transmission of the first TB. Without the TBS, UE 904 may be unable to decode the first re-transmission of the first TB (e.g., sent to UE 904 at 920). Thus, at 922 and 924, respectively, UE 904 may discard the first TB and send, to network entity 902, NACK feedback for the first TB. The NACK feedback may indicate, to network entity 902, that the first TB needs to again be re-transmitted.

Although not shown in FIG. 9, upon receiving the NACK feedback, the network entity 902 may again send, to UE 904, another DCI scheduling another re-transmission of the first TB and the first TB itself. UE 904 may be unable to determine a TBS for the first TB; thus, this cycle may repeat, at least until network entity 902 exhaustion (e.g., similar to legacy operations where no TBS information is included in a DCI scheduling a re-transmission of a TB).

Note that the process flow 900 illustrated in FIG. 9 is described herein to facilitate an understanding of TBS information communication, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a UE

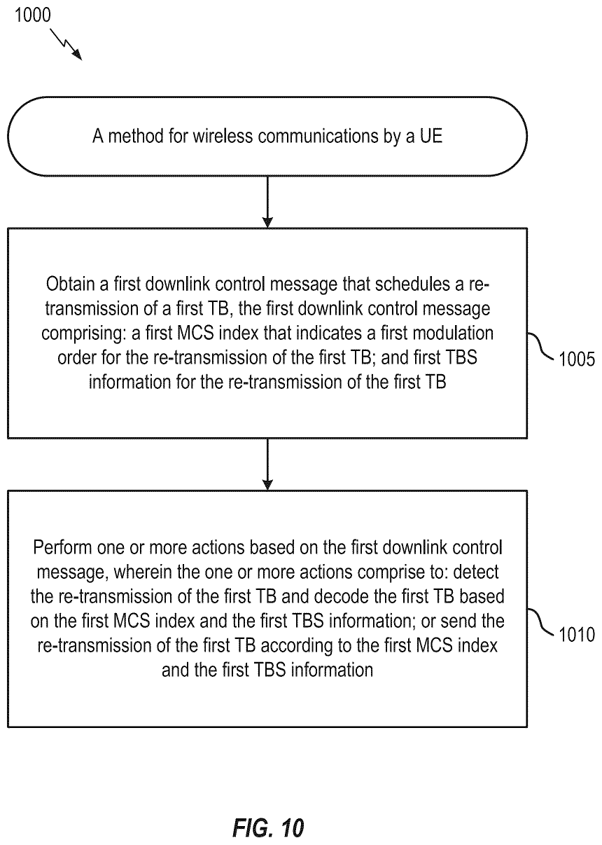

FIG. 10 shows a method 1000 for wireless communications by a UE, such as UE 104 of FIG. 1 or UE 304 of FIG. 3.

Method 1000 begins at block 1005 with receiving a first downlink control message that schedules a re-transmission of a first TB, the first downlink control message comprising: a first MCS index that indicates a first modulation order for the re-transmission of the first TB; and first TBS information for the re-transmission of the first TB. An example of block 1005 (e.g., example receiving a first downlink control message that schedules a re-transmission of a first TB) is depicted and described above with respect to step 718 of FIG. 7, step 816 of FIG. 8, and step 918 of FIG. 9.

Method 1000 then proceeds to block 1010 with performing one or more actions based on the first downlink control message, wherein the one or more actions comprise: detecting the re-transmission of the first TB and decoding the first TB based on the first MCS index and the first TBS information; or sending the re-transmission of the first TB according to the first MCS index and the first TBS information. An example of block 1010 (e.g., example performing one or more actions based on the first downlink control message) is depicted and described above with respect to steps 720 and 722 of FIG. 7 and steps 818 and 820 of FIG. 8.

In some aspects, method 1000 further includes receiving signaling indicating: a plurality of values for TBS information; and a plurality of indications of TBS, each of the plurality of indications of TBS associated with a respective value of the plurality of values.

In some aspects, the first TBS information is set to a first value, of the plurality of values, that is associated with an indication of TBS, of the plurality of indications of TBS, that a first TBS for the re-transmission of the first TB comprises a second TBS of a second downlink control message.

In some aspects, the second downlink control message comprises a downlink control message decoded, last-in-time, by the UE.

In some aspects, the first TBS information is set to a first value, of the plurality of values, that is associated with an indication of TBS, among the plurality of indications of TBS, of a first TBS for the re-transmission of the first TB.

In some aspects, method 1000 further includes receiving a second downlink control message that schedules a re-transmission of a second TB, the second downlink control message comprising: a second MCS index that indicates a second modulation order for the re-transmission of the second TB; and an indication that second TBS information for the re-transmission of the second TB is unavailable.

In some aspects, method 1000 further includes performing one or more other actions based on the second downlink control message, wherein the one or more other actions comprise: detecting and discarding the re-transmission of the second TB; or not sending the re-transmission of the TB.

In some aspects, the second MCS index further indicates to determine a second TBS for the re-transmission of the second TB based on a third downlink control message that schedules an initial transmission of the second TB.

In some aspects, the re-transmission of the first TB comprises a downlink transmission; and the one or more actions (e.g., performed at block 1010) comprise detecting the re-transmission of the first TB and decoding the first TB based on the first MCS index and the first TBS information.

In some aspects, the re-transmission of the first TB comprises an uplink transmission; and the one or more actions (e.g., performed at block 1010) comprise sending the re-transmission of the first TB according to the first MCS index and the first TBS information.

In some aspects, before receiving the first downlink control message, method 1000 further includes canceling monitoring for a second downlink control message that schedules an initial transmission of the first TB.

In some aspects, before receiving the first downlink control message, method 1000 further includes attempting to decode the second downlink control message and determining that the decoding is unsuccessful.

In some aspects, the first MCS index further indicates to determine a first TBS for the re-transmission of the first TB based on a second downlink control message that schedules an initial transmission of the first TB.

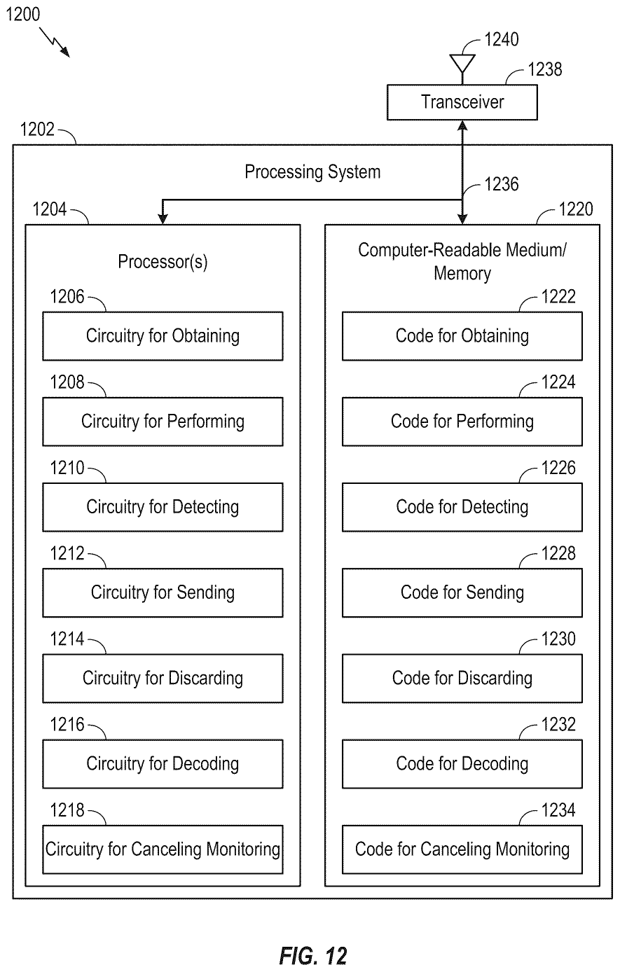

In some aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Operations of a Network Entity

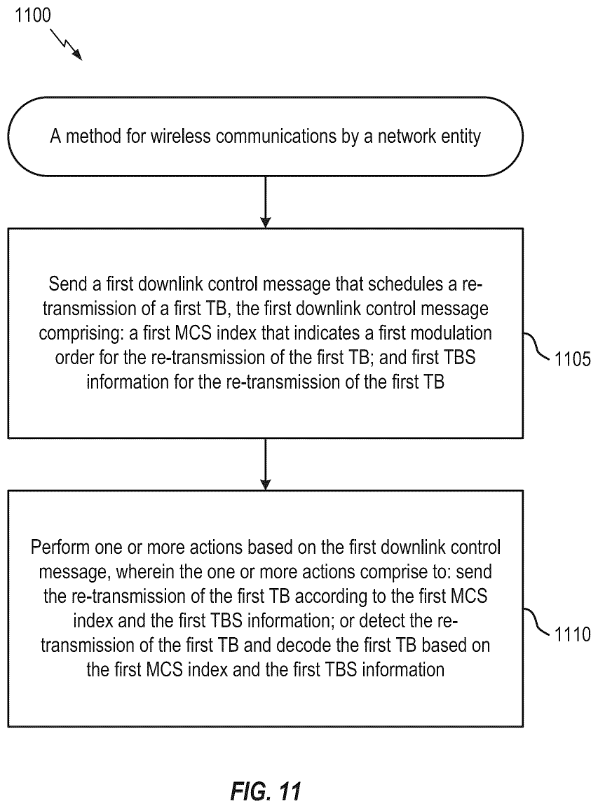

FIG. 11 shows a method 1100 for wireless communications by a network entity, such as BS 102 of FIG. 1, a first network entity 300 or second network entity 302 of FIG. 3, or a disaggregated base station as discussed with respect to FIG. 2.

Method 1100 begins at block 1105 with sending a first downlink control message that schedules a re-transmission of a first TB, the first downlink control message comprising: a first MCS index that indicates a first modulation order for the re-transmission of the first TB; and first TBS information for the re-transmission of the first TB. An example of block 1105 (e.g., example sending a first downlink control message that schedules a re-transmission of a first TB) is depicted and described above with respect to step 718 of FIG. 7, step 816 of FIG. 8, and step 918 of FIG. 9.

Method 1100 then proceeds to block 1110 with performing one or more actions based on the first downlink control message, wherein the one or more actions comprise: sending the re-transmission of the first TB according to the first MCS index and the first TBS information; or detecting the re-transmission of the first TB and decoding the first TB based on the first MCS index and the first TBS information. An example of block 1110 (e.g., example performing one or more actions based on the first downlink control message) is depicted and described above with respect to step 720 of FIG. 7, step 820 of FIG. 8, and step 920 of FIG. 9.

In certain aspects, method 1100 further includes sending signaling indicating: a plurality of values for TBS information; and a plurality of indications of TBS, each of the plurality of indications of TBS associated with a respective value of the plurality of values.

In some aspects, the first TBS information is set to a first value, of the plurality of values, that is associated with an indication of TBS, of the plurality of indications of TBS, that a first TBS for the re-transmission of the first TB comprises a second TBS of a second downlink control message.

In some aspects, block 1105 includes sending the first downlink control message to a UE; and the second downlink control message comprises a downlink control message decoded, last-in-time, by the UE.

In some aspects, the first TBS information is set to a first value, of the plurality of values, that is associated with an indication of TBS, among the plurality of indications of TBS, of a first TBS for the re-transmission of the first TB.

In certain aspects, method 1100 further includes sending a second downlink control message that schedules a re-transmission of a second TB, the second downlink control message comprising: a second MCS index that indicates a second modulation order for the re-transmission of the second TB; and an indication that second TBS information for the re-transmission of the second TB is unavailable.

In certain aspects, method 1100 further includes detecting and discarding the re-transmission of the second TB.

In certain aspects, method 1100 further includes not sending the re-transmission of the TB.

In some aspects, the second MCS index further indicates to determine a second TBS for the re-transmission of the second TB based on a third downlink control message that schedules an initial transmission of the second TB.

In some aspects, the re-transmission of the first TB comprises a downlink transmission; and the one or more actions (e.g., performed at block 1110) comprise sending the re-transmission of the first TB according to the first MCS index and the first TBS information.

In some aspects, the re-transmission of the first TB comprises an uplink transmission; and the one or more actions (e.g., performed at block 1110) comprise detecting the re-transmission of the first TB and decoding the first TB based on the first MCS index and the first TBS information.

In certain aspects, before sending the first downlink control message, method 1100 further includes sending a second downlink control message that schedules an initial transmission of the first TB.

In certain aspects, before sending the first downlink control message, method 1100 further includes sending the initial transmission of the first TB.

In some aspects, the first MCS index further indicates to determine a first TBS for the re-transmission of the first TB based on a second downlink control message that schedules an initial transmission of the first TB.

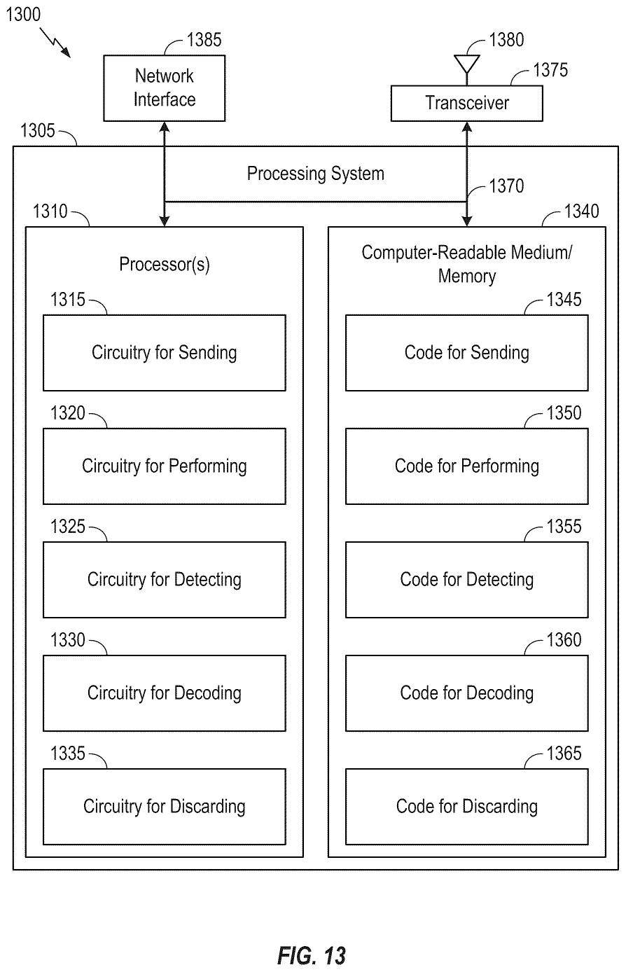

In some aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1202 coupled to a transceiver 1238 (e.g., a transmitter and/or a receiver). The transceiver 1238 is configured to transmit and receive signals for the communications device 1200 via an antenna 1240, such as the various signals as described herein. The processing system 1202 may be configured to perform processing functions for the communications device 1200, including processing signals received and/or to be transmitted by the communications device 1200.

The processing system 1202 includes one or more processors 1204 and a computer-readable medium/memory 1220. In various aspects, the one or more processors 1204 may be representative of the one or more processors 318 described with respect to FIG. 3. The one or more processors 1204 are coupled to a computer-readable medium/memory 1220 via a bus 1236. In some aspects, the computer-readable medium/memory 1220 may be representative of the one or more memories 320 described with respect to FIG. 3. The computer-readable medium/memory 1220 is a non-transitory computer-readable medium/memory. In certain aspects, the computer-readable medium/memory 1220 is configured to store instructions (e.g., computer-executable code), that when executed by the one or more processors 1204, cause the one or more processors 1204 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1220 stores code (e.g., executable instructions), including code for receiving 1222, code for performing 1224, code for detecting 1226, code for sending 1228, code for discarding 1230, code for decoding 1232, and code for canceling monitoring 1234. Processing of the code 1222-1234 may enable and cause the communications device 1200 to perform the method 1000 described with respect to FIG. 10, or any aspect related to it. For example, in some aspects, code for receiving 1222 includes code for receiving a first downlink control message that schedules a re-transmission of a first TB, the first downlink control message comprising: a first MCS index that indicates a first modulation order for the re-transmission of the first TB; and first TBS information for the re-transmission of the first TB. In some aspects, code for performing 1224 includes code for performing one or more actions based on the first downlink control message. In some aspects, code for detecting 1226 includes code for detecting the re-transmission of the first TB. In some aspects, code for decoding 1232 includes code for decoding the first TB based on the first MCS index and the first TBS information. In some aspects, code for sending 1228 includes code for sending the re-transmission of the first TB according to the first MCS index and the first TBS information.

The one or more processors 1204 include circuitry configured to implement (e.g., execute) the code stored in the computer-readable medium/memory 1220, including circuitry for receiving 1206, circuitry for performing 1208, circuitry for detecting 1210, circuitry for sending 1212, circuitry for discarding 1214, circuitry for decoding 1216, and circuitry for canceling monitoring 1218. Processing with circuitry 1206-1218 may enable and cause the communications device 1200 to perform the method 1000 described with respect to FIG. 10, or any aspect related to it. For example, in some aspects, circuitry for receiving 1206 includes circuitry for receiving a first downlink control message that schedules a re-transmission of a first TB, the first downlink control message comprising: a first MCS index that indicates a first modulation order for the re-transmission of the first TB; and first TBS information for the re-transmission of the first TB. In some aspects, circuitry for performing 1208 includes circuitry for performing one or more actions based on the first downlink control message. In some aspects, circuitry for detecting 1210 includes circuitry for detecting the re-transmission of the first TB. In some aspects, circuitry for decoding 1216 includes circuitry for decoding the first TB based on the first MCS index and the first TBS information. In some aspects, circuitry for sending 1212 includes circuitry for sending the re-transmission of the first TB according to the first MCS index and the first TBS information.

More generally, means for communicating, transmitting, sending or outputting for transmission may include the one or more transceivers 324, one or more antenna 322 and/or processing system 316 of the UE 304 illustrated in FIG. 3, transceiver 1238 and/or antenna 1240 of the communications device 1200 in FIG. 12, and/or one or more processors 1204 of the communications device 1200 in FIG. 12. Means for communicating, receiving or receiving may include the one or more transceivers 324, one or more antennas 322, and/or processing system 316 of the UE 304 illustrated in FIG. 3, transceiver 1238 and/or antenna 1240 of the communications device 1200 in FIG. 12, and/or one or more processors 1204 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1375 (e.g., a transmitter and/or a receiver) and/or a network interface 1385. The transceiver 1375 is configured to transmit and receive signals for the communications device 1300 via an antenna 1380, such as the various signals as described herein. The network interface 1385 is configured to receive and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1340. In various aspects, one or more processors 1310 may be representative of the one or more processors 308, as described with respect to FIG. 3. The one or more processors 1310 are coupled to the computer-readable medium/memory 1340 via a bus 1370. In certain aspects, the computer-readable medium/memory 1340 is configured to store instructions (e.g., computer-executable code), including code 1345-1365, that when executed by the one or more processors 1310, cause the one or more processors 1310 to perform the method 1100 described with respect to FIG. 11, or any aspect related to it, including any operations described in relation to FIG. 11. The computer-readable medium/memory 1340 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1340 stores code (e.g., executable instructions), including code for sending 1345, code for performing 1350, code for detecting 1355, code for decoding 1360, and code for discarding 1365. Processing of the code 1345-1365 may enable and cause the communications device 1300 to perform the method 1100 described with respect to FIG. 11, or any aspect related to it. For example, in some aspects, code for sending 1345 includes code for sending a first downlink control message that schedules a re-transmission of a first TB, the first downlink control message comprising: a first MCS index that indicates a first modulation order for the re-transmission of the first TB; and first TBS information for the re-transmission of the first TB. In some aspects, code for performing 1350 includes code for performing one or more actions based on the first downlink control message. In some aspects, code for sending 1345 includes code for sending the re-transmission of the first TB according to the first MCS index and the first TBS information. In some aspects, code for detecting 1355 includes code for detecting the re-transmission of the first TB based on the first MCS index and the first TBS information. In some aspects, code for decoding 1360 includes code for decoding the first TB based on the first MCS index and the first TBS information.

The one or more processors 1310 include circuitry configured to implement (e.g., execute) the code stored in the computer-readable medium/memory 1340, including circuitry for sending 1315, circuitry for performing 1320, circuitry for detecting 1325, circuitry for decoding 1330, and circuitry for discarding 1335. Processing with circuitry 1315-1335 may enable and cause the communications device 1300 to perform the method 1100 described with respect to FIG. 11, or any aspect related to it. For example, in some aspects, circuitry for sending 1315 includes circuitry for sending a first downlink control message that schedules a re-transmission of a first TB, the first downlink control message comprising: a first MCS index that indicates a first modulation order for the re-transmission of the first TB; and first TBS information for the re-transmission of the first TB. In some aspects, circuitry for performing 1320 includes circuitry for performing one or more actions based on the first downlink control message. In some aspects, circuitry for sending 1315 includes circuitry for sending the re-transmission of the first TB according to the first MCS index and the first TBS information. In some aspects, circuitry for detecting 1325 includes circuitry for detecting the re-transmission of the first TB based on the first MCS index and the first TBS information. In some aspects, circuitry for decoding 1330 includes circuitry for decoding the first TB based on the first MCS index and the first TBS information.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1375, antenna 1380, and/or network interface 1385 of the communications device 1300 in FIG. 13, and/or one or more processors 1310 of the communications device 1300 in FIG. 13. Means for communicating, receiving or receiving may include the one or more transceivers 312, one or more antennas 314, and/or processing system 306 of the first network entity 300 or the second network entity 302 illustrated in FIG. 3, transceiver 1375, antenna 1380, and/or network interface 1385 of the communications device 1300 in FIG. 13, and/or one or more processors 1310 of the communications device 1300 in FIG. 13.

### Example Clauses

Implementation examples are described in the following numbered clauses:
Clause 1: A method for wireless communications by a UE comprising: receiving a first downlink control message that schedules a re-transmission of a first TB, the first downlink control message comprising: a first MCS index that indicates a first modulation order for the re-transmission of the first TB; and first TBS information for the re-transmission of the first TB; and performing one or more actions based on the first downlink control message, wherein the one or more actions comprise: detecting the re-transmission of the first TB and decoding the first TB based on the first MCS index and the first TBS information; or sending the re-transmission of the first TB according to the first MCS index and the first TBS information.
Clause 2: The method of Clause 1, further comprising receiving signaling indicating: a plurality of values for TBS information; and a plurality of indications of TBS, each of the plurality of indications of TBS associated with a respective value of the plurality of values.
Clause 3: The method of Clause 2, wherein the first TBS information is set to a first value, of the plurality of values, that is associated with an indication of TBS, of the plurality of indications of TBS, that a first TBS for the re-transmission of the first TB comprises a second TBS of a second downlink control message.
Clause 4: The method of Clause 3, wherein the second downlink control message comprises a downlink control message decoded, last-in-time, by the UE.
Clause 5: The method of Clause 2, wherein the first TBS information is set to a first value, of the plurality of values, that is associated with an indication of TBS, among the plurality of indications of TBS, of a first TBS for the re-transmission of the first TB.
Clause 6: The method of any one of Clauses 1-5, further comprising: receiving a second downlink control message that schedules a re-transmission of a second TB, the second downlink control message comprising: a second MCS index that indicates a second modulation order for the re-transmission of the second TB; and an indication that second TBS information for the re-transmission of the second TB is unavailable; and performing one or more other actions based on the second downlink control message, wherein the one or more other actions comprise: detecting and discarding the re-transmission of the second TB; or not sending the re-transmission of the TB.
Clause 7: The method of Clause 6, wherein the second MCS index further indicates to determine a second TBS for the re-transmission of the second TB based on a third downlink control message that schedules an initial transmission of the second TB.
Clause 8: The method of any one of Clauses 1-7, wherein: the re-transmission of the first TB comprises a downlink transmission; and the one or more actions comprise detecting the re-transmission of the first TB and decoding the first TB based on the first MCS index and the first TBS information.
Clause 9: The method of any one of Clauses 1-8, wherein: the re-transmission of the first TB comprises an uplink transmission; and the one or more actions comprise to send the re-transmission of the first TB according to the first MCS index and the first TBS information.
Clause 10: The method of any one of Clauses 1-9, further comprising, before receiving the first downlink control message: canceling monitoring for a second downlink control message that schedules an initial transmission of the first TB; and attempting to decode the second downlink control message and determining that the decoding is unsuccessful.
Clause 11: The method of any one of Clauses 1-10, wherein the first MCS index further indicates to determine a first TBS for the re-transmission of the first TB based on a second downlink control message that schedules an initial transmission of the first TB.
Clause 12: A method for wireless communications by a network entity comprising: sending a first downlink control message that schedules a re-transmission of a first TB, the first downlink control message comprising: a first MCS index that indicates a first modulation order for the re-transmission of the first TB; and first TBS information for the re-transmission of the first TB; and performing one or more actions based on the first downlink control message, wherein the one or more actions comprise: sending the re-transmission of the first TB according to the first MCS index and the first TBS information; or detecting the re-transmission of the first TB and decoding the first TB based on the first MCS index and the first TBS information.
Clause 13: The method of Clause 12, further comprising sending signaling indicating: a plurality of values for TBS information; and a plurality of indications of TBS, each of the plurality of indications of TBS associated with a respective value of the plurality of values.
Clause 14: The method of Clause 13, wherein the first TBS information is set to a first value, of the plurality of values, that is associated with an indication of TBS, of the plurality of indications of TBS, that a first TBS for the re-transmission of the first TB comprises a second TBS of a second downlink control message.
Clause 15: The method of Clause 14, wherein: sending the first downlink control message comprises sending the first downlink control message to a UE; and the second downlink control message comprises a downlink control message decoded, last-in-time, by the UE.
Clause 16: The method of Clause 13, wherein the first TBS information is set to a first value, of the plurality of values, that is associated with an indication of TBS, among the plurality of indications of TBS, of a first TBS for the re-transmission of the first TB.
Clause 17: The method of any one of Clauses 12-16, further comprising: sending a second downlink control message that schedules a re-transmission of a second TB, the second downlink control message comprising: a second MCS index that indicates a second modulation order for the re-transmission of the second TB; and an indication that second TBS information for the re-transmission of the second TB is unavailable; detecting and discarding the re-transmission of the second TB; and not sending the re-transmission of the TB.
Clause 18: The method of Clause 17, wherein the second MCS index further indicates to determine a second TBS for the re-transmission of the second TB based on a third downlink control message that schedules an initial transmission of the second TB.
Clause 19: The method of any one of Clauses 12-18, wherein: the re-transmission of the first TB comprises a downlink transmission; and the one or more actions comprise to send the re-transmission of the first TB according to the first MCS index and the first TBS information.
Clause 20: The method of any one of Clauses 12-19, wherein: the re-transmission of the first TB comprises an uplink transmission; and the one or more actions comprise detecting the re-transmission of the first TB and decoding the first TB based on the first MCS index and the first TBS information.
Clause 21: The method of any one of Clauses 12-20, further comprising, before sending the first downlink control message: sending a second downlink control message that schedules an initial transmission of the first TB; and sending the initial transmission of the first TB.
Clause 22: The method of any one of Clauses 12-21, wherein the first MCS index further indicates to determine a first TBS for the re-transmission of the first TB based on a second downlink control message that schedules an initial transmission of the first TB.
Clause 23: One or more apparatuses, comprising: one or more memories comprising executable instructions; and one or more processors configured to execute the executable instructions and cause the one or more apparatuses to perform a method in accordance with any one of Clauses 1-22.
Clause 24: One or more apparatuses configured for wireless communications, comprising: one or more memories; and one or more processors, coupled to the one or more memories, configured to cause the one or more apparatuses to perform a method in accordance with any one of Clauses 1-22.
Clause 25: One or more apparatuses configured for wireless communications, comprising: one or more memories; and one or more processors, coupled to the one or more memories, configured to perform a method in accordance with any one of Clauses 1-22.
Clause 26: One or more apparatuses, comprising means for performing a method in accordance with any one of Clauses 1-22.
Clause 27: One or more non-transitory computer-readable media comprising executable instructions that, when executed by one or more processors of one or more apparatuses, cause the one or more apparatuses to perform a method in accordance with any one of Clauses 1-22.
Clause 28: One or more computer program products embodied on one or more computer-readable storage media comprising code for performing a method in accordance with any one of Clauses 1-22.
Clause 29: One or more apparatuses configured for wireless communications, comprising: a processing system that includes one or more processors and one or more memories coupled with the one or more processors, the processing system configured to cause the one or more apparatuses to perform a method in accordance with any one of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive a first downlink control message that schedules a re-transmission of a first transport block (TB), the first downlink control message comprising:
a first modulation and coding scheme (MCS) index that indicates a first modulation order for the re-transmission of the first TB; and
first TB size (TBS) information for the re-transmission of the first TB; and
perform one or more actions based on the first downlink control message, wherein the one or more actions comprise to:
detect the re-transmission of the first TB and decode the first TB based on the first MCS index and the first TBS information; or
send the re-transmission of the first TB according to the first MCS index and the first TBS information.

2. The apparatus of claim 1, wherein the processing system is configured to cause the UE to receive signaling indicating:
a plurality of values for TBS information; and
a plurality of indications of TBS, each of the plurality of indications of TBS associated with a respective value of the plurality of values.

3. The apparatus of claim 2, wherein the first TBS information is set to a first value, of the plurality of values, that is associated with an indication of TBS, of the plurality of indications of TBS, that a first TBS for the re-transmission of the first TB comprises a second TBS of a second downlink control message.

4. The apparatus of claim 3, wherein the second downlink control message comprises a downlink control message decoded, last-in-time, by the UE.

5. The apparatus of claim 2, wherein the first TBS information is set to a first value, of the plurality of values, that is associated with an indication of TBS, among the plurality of indications of TBS, of a first TBS for the re-transmission of the first TB.

6. The apparatus of claim 1, wherein the processing system is configured to cause the UE to:
receive a second downlink control message that schedules a re-transmission of a second TB, the second downlink control message comprising:
a second MCS index that indicates a second modulation order for the re-transmission of the second TB; and
an indication that second TBS information for the re-transmission of the second TB is unavailable; and
based on the second downlink control message, perform one or more other actions, wherein the one or more other actions comprise to:
detect and discard the re-transmission of the second TB; or
not send the re-transmission of the TB.

7. The apparatus of claim 6, wherein the second MCS index further indicates to determine a second TBS for the re-transmission of the second TB based on a third downlink control message that schedules an initial transmission of the second TB.

8. The apparatus of claim 1, wherein:
the re-transmission of the first TB comprises a downlink transmission; and
the one or more actions comprise to detect the re-transmission of the first TB and decode the first TB based on the first MCS index and the first TBS information.

9. The apparatus of claim 1, wherein:
the re-transmission of the first TB comprises an uplink transmission; and
the one or more actions comprise to send the re-transmission of the first TB according to the first MCS index and the first TBS information.

10. The apparatus of claim 1, wherein the processing system is configured to cause the UE to:
before receiving the first downlink control message:
cancel monitoring for a second downlink control message that schedules an initial transmission of the first TB; or
attempt to decode the second downlink control message and determine that the decoding is unsuccessful.

11. The apparatus of claim 1, wherein the first MCS index further indicates to determine a first TBS for the re-transmission of the first TB based on a second downlink control message that schedules an initial transmission of the first TB.

12. A method for wireless communications by a user equipment (UE), comprising:
receiving a first downlink control message that schedules a re-transmission of a first transport block (TB), the first downlink control message comprising:
a first modulation and coding scheme (MCS) index that indicates a first modulation order for the re-transmission of the first TB; and
first TB size (TBS) information for the re-transmission of the first TB; and
performing one or more actions based on the first downlink control message, wherein the one or more actions comprise:
detecting the re-transmission of the first TB and decoding the first TB based on the first MCS index and the first TBS information; or
sending the re-transmission of the first TB according to the first MCS index and the first TBS information.

13. The method of claim 12, further comprising receiving signaling indicating:
a plurality of values for TBS information; and
a plurality of indications of TBS, each of the plurality of indications of TBS associated with a respective value of the plurality of values.

14. The method of claim 13, wherein the first TBS information is set to a first value, of the plurality of values, that is associated with an indication of TBS, of the plurality of indications of TBS, that a first TBS for the re-transmission of the first TB comprises a second TBS of a second downlink control message.

15. The method of claim 14, wherein the second downlink control message comprises a downlink control message decoded, last-in-time, by the UE.

16. The method of claim 13, wherein the first TBS information is set to a first value, of the plurality of values, that is associated with an indication of TBS, among the plurality of indications of TBS, of a first TBS for the re-transmission of the first TB.

17. The method of claim 12, further comprising:
receiving a second downlink control message that schedules a re-transmission of a second TB, the second downlink control message comprising:
a second MCS index that indicates a second modulation order for the re-transmission of the second TB; and
an indication that second TBS information for the re-transmission of the second TB is unavailable; and
based on the second downlink control message, performing one or more other actions, wherein the one or more other actions comprise:
detecting and discarding the re-transmission of the second TB; or
not sending the re-transmission of the TB.

18. The method of claim 17, wherein the second MCS index further indicates to determine a second TBS for the re-transmission of the second TB based on a third downlink control message that schedules an initial transmission of the second TB.

19. The method of claim 12, wherein:
the re-transmission of the first TB comprises a downlink transmission; and
the one or more actions comprise detecting the re-transmission of the first TB and decode the first TB based on the first MCS index and the first TBS information.

20. One or more non-transitory computer-readable media comprising executable instructions that, when executed by one or more processors of an apparatus, cause the apparatus to perform operations comprising:
receiving a first downlink control message that schedules a re-transmission of a first transport block (TB), the first downlink control message comprising:
a first modulation and coding scheme (MCS) index that indicates a first modulation order for the re-transmission of the first TB; and
first TB size (TBS) information for the re-transmission of the first TB; and
performing one or more actions based on the first downlink control message, wherein the one or more actions comprise:
detecting the re-transmission of the first TB and decoding the first TB based on the first MCS index and the first TBS information; or
sending the re-transmission of the first TB according to the first MCS index and the first TBS information.
